(19) United States
(12) Patent Application Publication
(10) Pub. No.: US 2014/0283915 A1
(43) Pub. Date: Sep. 25, 2014

(54) Hydraulic Control System Having Relief Flow Capture

(71) Applicant: CATERPILLAR INC., Peoria, IL (US)

(72) Inventors: Pengfei Ma, Naperville, IL (US); Dayao Chen, Bolingbrook, IL (US); Jiao Zhang, Naperville, IL (US); Tonglin Shang, Bolingbrook, IL (US); Gang Wen, Dunlap, IL (US)

(73) Assignee: Caterpillar Inc., Peoria, IL (US)

(21) Appl. No.: 13/848,391

(22) Filed: Mar. 21, 2013

(51) Int. Cl. F15B 1/027

(52) U.S. Cl. CPC F15B 1/027
USPC 137/1; 137/565.19

(57) ABSTRACT

A hydraulic circuit may be provided. The circuit may include: a pump to supply pressurized fluid to a circuit; a supply passageway coupled between the pump and the circuit; a relief flow passageway coupled between the supply passageway and a fluid reservoir; a relief flow capture circuit coupled to the relief flow passageway, the relief flow capture circuit including: a first valve configured to move from a closed position to an open position when a first pressure is detected; a second valve in fluid communication with the first valve, the second valve configured to move from a closed position to an open position when a second pressure is detected wherein the second pressure is lower than the first pressure; and an accumulator located between the first and second valves and in fluid communication with both the first and second valves, the accumulator configured to store fluid flowing through the first valve when the first pressure valve is in an open position, the accumulator further configured to outflow fluid through the second valve when the second valve is in an open position.

### TECHNICAL FIELD

The present disclosure relates generally to a hydraulic control system and, more particularly, to a hydraulic control system having a relief flow capture feature.

### BACKGROUND

Machines such as excavators, loaders, dozers, motor graders, and other types of heavy equipment use one or more actuators supplied with hydraulic fluid from a pump on the machine to accomplish a variety of tasks. These actuators are typically velocity controlled based on an actuation position of an operator interface device. For example, an operator interface device such as a joystick, a pedal, or another suitable device may be movable to generate a signal indicative of a desired velocity of an associated hydraulic actuator. When an operator moves the interface device, the operator expects the hydraulic actuator to move at an associated predetermined velocity.

In some situations, it may be possible for a pressure of the fluid supplied to the actuator(s) to exceed a desired level. This over-pressure situation can occur, for example, when work tool movement becomes stalled (e.g., when the work tool strikes against an immovable object). In these situations, the actuator or other components of the associated system can malfunction or be damaged. Accordingly, care should be taken to avoid such occurrences.

Conventionally, over-pressure situations can be dealt with in several different ways. In one way, a main pressure relief valve associated with the system can open when system pressure exceeds a desired pressure. High-pressure fluid from the system is then dumped through the open valve into a low-pressure tank, thereby reducing the pressure of the system. Although effective, this strategy can be inefficient, as the dumped fluid contains significant energy that is wasted. This energy may be in the form of heat and/or pressure. The wasted energy dissipated in the form of heat may create a cooling issue. Furthermore, moving hydraulic fluid to the reservoir or tank during overpressure situations can result in a shortage of hydraulic fluid once the circuit has returned to normal operation.

One example of a system that attempts to recapture energy from a hydraulic pump is described in JP 2003049809. In this system, pressurized hydraulic fluid is used to generate electric energy. However, this system does not permit the energy to stay within the hydraulic system as the pressure is transformed into electric energy.

### SUMMARY

In some embodiments a hydraulic circuit may be provided. The circuit may include: a pump to supply pressurized fluid to a circuit; a supply passageway coupled between the pump and the circuit; a relief flow passageway coupled between the supply passageway and a fluid reservoir; a relief flow capture circuit coupled to the relief flow passageway, the relief flow capture circuit including: a first valve configured to move from a closed position to an open position when a first pressure is detected; a second valve in fluid communication with the first valve, the second valve configured to move from a closed position to an open position when a second pressure is detected wherein the second pressure is lower than the first pressure; and an accumulator located between the first and second valves and in fluid communication with both the first and second valves, the accumulator configured to store fluid flowing through the first valve when the first pressure valve is in an open position, the accumulator further configured to outflow fluid through the second valve when the second valve is in an open position.

In other embodiments a method of capturing relief flow may be provided. The method may include moving a first valve of a relief flow capture circuit from a closed position to an open position when a first pressure is detected to charge an accumulator, the relief flow capture circuit coupled to a relief flow passageway that is coupled between a supply passageway and a fluid reservoir, the supply passageway coupled to a pump configured to supply pressurized fluid to a circuit; and moving a second valve of the relief flow capture circuit from a closed position to an open position when a second pressure is detected to discharge the accumulator, wherein the second pressure is lower than the first pressure, the second valve in series with the first valve.

In still other embodiments, a hydraulic circuit may be provided. The circuit may include means for supplying pressurized fluid to a circuit; a supply passageway coupled between the means for supplying pressurized fluid and the circuit; a relief flow passageway coupled between the supply passageway and a fluid reservoir; a relief flow capture circuit coupled to the relief flow passageway, the relief flow capture circuit including: a first means for selectively allowing and disallowing fluid flow configured to move from a closed position to an open position at a first pressure; a second means for selectively allowing and disallowing fluid flow in fluid communication with the first means for selectively allowing and disallowing fluid flow, the second means for selectively allowing and disallowing fluid flow configured to move from a closed position to an open position at a second pressure wherein the second pressure is lower than the first pressure; and an accumulator located between the first and second means for selectively allowing and disallowing fluid flow and in fluid communication with both the first and second means for selectively allowing and disallowing fluid flow, the accumulator configured to store fluid flowing through the first means for selectively allowing and disallowing fluid flow when the first means for selectively allowing and disallowing fluid flow is in an open position and the second means for selectively allowing and disallowing fluid flow is in a closed position, the accumulator further configured to outflow fluid through the second pressure valve when the second means for selectively allowing and disallowing fluid flow is in an open position.

### BRIEF DESCRIPTION OF THE DRAWINGS

FIG. 1 is a diagrammatic illustration of an exemplary disclosed machine in a working environment;

FIG. 2 is a schematic illustration of an exemplary disclosed hydraulic control system that may be used with the machine of FIG. 1;

FIG. 3 is a schematic diagram of a relief capture circuit in accordance with an embodiment in accordance with the disclosure;

FIG. 4 is a schematic diagram of a relief capture circuit in accordance with another embodiment; and

FIG. 5 is a schematic diagram of a relief capture circuit in accordance with additional features than the embodiment shown in FIG. 4.

### DETAILED DESCRIPTION

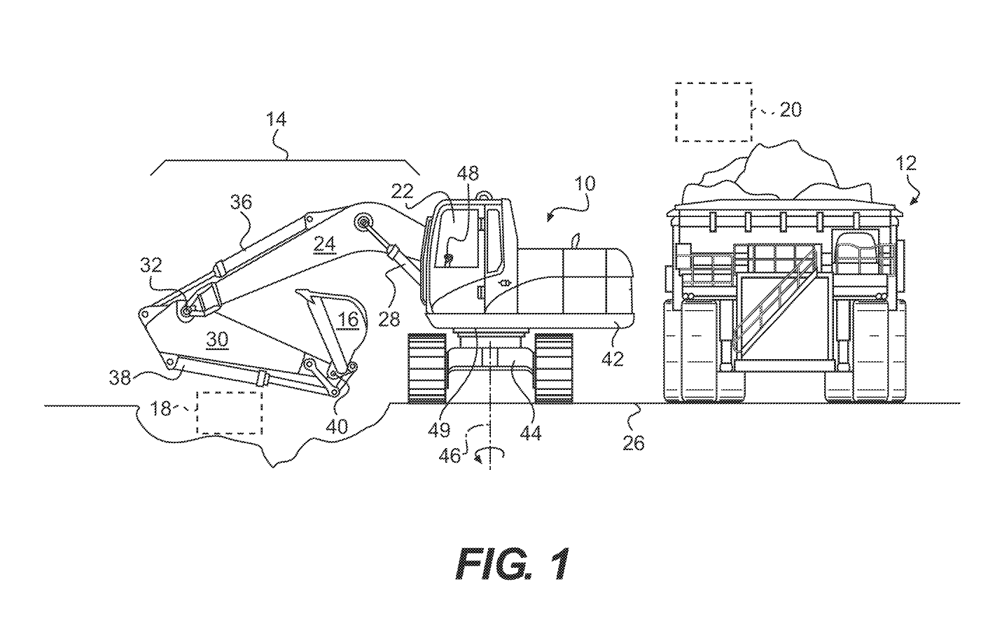

FIG. 1 illustrates an exemplary machine 10 having multiple systems and components that cooperate to excavate and load earthen material onto a nearby haul vehicle 12. In the depicted example, machine 10 is a hydraulic excavator. It is contemplated; however, that machine 10 could alternatively embody another type of excavation or material handling machine, such as a backhoe, a front shovel, a motor grader, a dozer, or another similar machine. Machine 10 may include, among other things, an implement system 14 configured to move a work tool 16 between a dig location 18 within a trench or at a pile, and a dump location 20, for example over haul vehicle 12. Machine 10 may also include an operator station 22 for manual control of implement system 14. It is contemplated that machine 10 may perform operations other than truck loading, if desired, such as craning, trenching, material handling, bulk material removal, grading, dozing, etc.

Implement system 14 may include a linkage structure acted on by fluid actuators to move work tool 16. Specifically, implement system 14 may include a boom 24 that is vertically pivotal relative to a work surface 26 by a pair of adjacent, double-acting, hydraulic cylinders 28 (only one shown in FIG. 1). Implement system 14 may also include a stick 30 that is vertically pivotal about a horizontal pivot axis 32 relative to boom 24 by a single, double-acting, hydraulic cylinder 36. Implement system 14 may further include a single, double-acting, hydraulic cylinder 38 that is operatively connected to work tool 16 to tilt work tool 16 vertically about a horizontal pivot axis 40 relative to stick 30. Boom 24 may be pivotally connected to a frame 42 of machine 10, while frame 42 may be pivotally connected to an undercarriage member 44 and swung about a vertical axis 46 by a swing motor 49. Stick 30 may pivotally connect work tool 16 to boom 24 by way of pivot axes 32 and 40. It is contemplated that a different number and/or type of fluid actuators may be included within implement system 14 and connected in a manner other than described above, if desired.

Numerous different work tools 16 may be attachable to a single machine 10 and controllable via operator station 22. Work tool 16 may include any device used to perform a particular task such as, for example, a bucket, a fork arrangement, a blade, a shovel, a crusher, a shear, a grapple, a grapple bucket, a magnet, or any other task-performing device known in the art. Although connected in the embodiment of FIG. 1 to lift, swing, and tilt relative to machine 10, work tool 16 may alternatively or additionally rotate, slide, extend, open and close, or move in another manner known in the art.

Operator station 22 may be configured to receive input from a machine operator indicative of a desired work tool movement. Specifically, operator station 22 may include one or more interface devices 48 embodied, for example, as single or multi-axis joysticks located proximal an operator seat (not shown). Interface devices 48 may be proportional-type controllers configured to position and/or orient work tool 16 by producing work tool position signals that are indicative of a desired work tool speed and/or force in a particular direction. The position signals may be used to actuate any one or more of hydraulic cylinders 28, 36, 38 and/or swing motor 49. It is contemplated that different interface devices may alternatively or additionally be included within operator station 22 such as, for example, wheels, knobs, push-pull devices, switches, pedals, and other devices known in the art.

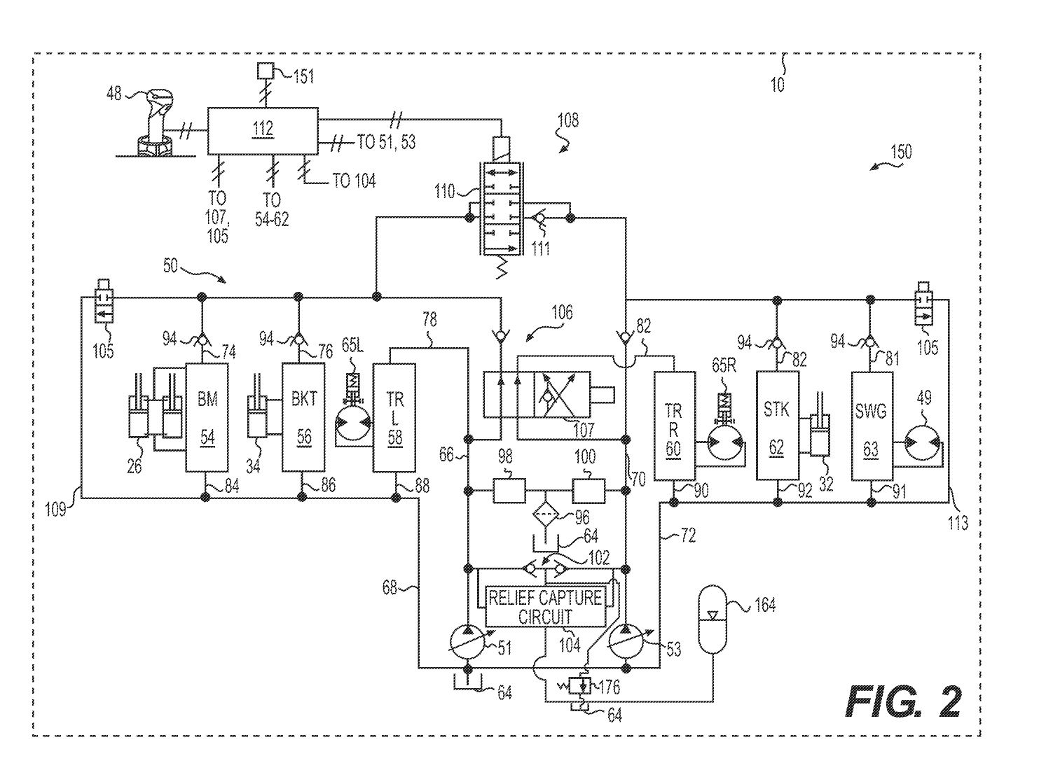

As illustrated in FIG. 2, machine 10 may include a hydraulic control system 150 having a plurality of fluid components that cooperate to move work tool 16 (referring to FIG. 1) and machine 10. In particular, hydraulic control system 150 may include a first circuit 50 configured to receive a first stream of pressurized fluid from a first source 51, and a second circuit 52 configured to receive a second stream of pressurized fluid from a second source 53. First circuit 50 may include a boom control valve 54, a bucket control valve 56, and a left travel control valve 58 connected to receive the first stream of pressurized fluid in parallel. Second circuit 52 may include a right travel control valve 60, a stick control valve 62, and a swing control valve 63 connected in parallel to receive the second stream of pressurized fluid. It is contemplated that additional control valve mechanisms may be included within first and/or second circuits 50, 52 such as, for example, one or more attachment control valves and other suitable control valve mechanisms.

First and second sources 51, 53 may draw fluid from one or more tanks 64 and pressurize the fluid to predetermined levels. Specifically, each of first and second sources 51, 53 may embody a pumping mechanism such as, for example, a variable displacement pump, a fixed displacement pump, or another source known in the art. First and second sources 51, 53 may each be separately and drivably connected to a power source (not shown) of machine 10 by, for example, a countershaft (not shown), a belt (not shown), an electrical circuit (not shown), or in any other suitable manner. Alternatively, each of first and second sources 51, 53 may be indirectly connected to the power source via a torque converter, a reduction gear box, or in another suitable manner First source 51 may produce the first stream of pressurized fluid independent of the second stream of pressurized fluid produced by second source 53. The first and second streams of pressurized fluids may be at different pressure levels and/or flow rates.

Tank 64 may constitute a reservoir configured to hold a supply of fluid. The fluid may include, for example, dedicated hydraulic oil, an engine lubrication oil, a transmission lubrication oil, or any other fluid known in the art. One or more hydraulic systems within machine 10 may draw fluid from and return fluid to tank 64. It is contemplated that hydraulic control system 150 may be connected to multiple separate fluid tanks or to a single tank.

Each of boom, bucket, left travel, right travel, stick, and swing control valves 54-63 may regulate the motion of their related fluid actuators. Specifically, boom control valve 54 may have elements movable to control the motion of hydraulic cylinders 28 associated with boom 24; bucket control valve 56 may have elements movable to control the motion of hydraulic cylinder 38 associated with work tool 16; and stick control valve 62 may have elements movable to control the motion of hydraulic cylinder 36 associated with stick 30. Likewise, left and right travel control valves 58, 60 may have valve elements movable to control the motion of left and right travel motors 65L, 65R (shown only in FIG. 2—associated with traction devices of machine 10); and swing control valve 63 may have elements movable to control the swinging motion of swing motor 49.

The control valves of first and second circuits 50, 52 may be connected to allow pressurized fluid to flow into and drain from their respective actuators via common passageways. Specifically, the control valves of first circuit 50 may be connected to first source 51 by way of a first common supply passageway 66, and to tank 64 by way of a first common drain passageway 68. The control valves of second circuit 52 may be connected to second source 53 by way of a second common supply passageway 70, and to tank 64 by way of a second common drain passageway 72. Boom, bucket, and left travel control valves 54-58 may be connected in parallel to first common supply passageway 66 by way of individual fluid passageways 74, 76, and 78, respectively, and in parallel to first common drain passageway 68 by way of individual fluid passageways 84, 86, and 88, respectively. Similarly, right travel, stick, and swing control valves 60, 62, 63 may be connected in parallel to second common supply passageway 70 by way of individual fluid passageways 80, 82, and 81 respectively, and in parallel to second common drain passageway 72 by way of individual fluid passageways 90, 92, and 91, respectively. A check valve 94 may be disposed within each of fluid passageways 74, 76, 82, and 81 to provide for unidirectional supply of pressurized fluid to control valves 54, 56, 62, and 63, respectively.

Because the elements of boom, bucket, left travel, right travel, stick, and swing control valves 54-63 may be similar and function in a related manner, only the operation of boom control valve 54 will be discussed in this disclosure. In one example, boom control valve 54 may include a first chamber supply element (not shown), a first chamber drain element (not shown), a second chamber supply element (not shown), and a second chamber drain element (not shown). The first and second chamber supply elements may be connected in parallel with fluid passageway 74 to fill respective chambers of hydraulic cylinders 28 with fluid from first source 51, while the first and second chamber drain elements may be connected in parallel with fluid passageway 84 to drain the respective chambers of fluid. To extend hydraulic cylinders 28, the first chamber supply element may be moved to allow the pressurized fluid from first source 51 to fill the first chambers of hydraulic cylinders 28 with pressurized fluid via fluid passageway 74, while the second chamber drain element may be moved to drain fluid from the second chambers of hydraulic cylinders 28 to tank 64 via fluid passageway 84. To move hydraulic cylinders 28 in the opposite direction, the second chamber supply element may be moved to fill the second chambers of hydraulic cylinders 28 with pressurized fluid, while the first chamber drain element may be moved to drain fluid from the first chambers of hydraulic cylinders 28. It is contemplated that both the supply and drain functions may alternatively be performed by a single element associated with the first chamber and a single element associated with the second chamber, or by a single element that controls all filling and draining functions of hydraulic cylinders 28.

The supply and drain elements of each control valve may be solenoid movable against a spring bias in response to a command. In particular, hydraulic cylinders 28, 36, 38, left and right travel motors 65L, 65R, and swing motor 49 may move at velocities that correspond to the flow rates of fluid into and out of corresponding pressure chambers and with forces that correspond with pressure differentials between the chambers. To achieve the operator-desired velocity indicated via the interface device position signal, a command based on an assumed or measured pressure may be sent to the solenoids (not shown) of the supply and drain elements that causes them to open an amount corresponding to the necessary flow rate. The command may be in the form of a flow rate command or a valve element position command.

The common supply and drain passageways of first and second circuits 50, 52 may be interconnected for makeup and relief functions. In particular, first and second common supply passageways 66, 70 may receive makeup fluid from tank 64 by way of a common filter 96 and first and second bypass elements 98, 100, respectively. As the pressure of the first or second streams of pressurized fluid drops below a predetermined level, fluid from tank 64 may be allowed to flow into first and second circuits 50, 52 by way of common filter 96 and first or second bypass elements 98, 100, respectively. In addition, first and second common drain passageways 68, 72 may relieve fluid from first and second circuits 50, 52 to tank 64. In particular, as fluid within first or second circuits 50, 52 exceeds a predetermined pressure level, fluid from the circuit having the excessive pressure may drain to tank 64 by way of a shuttle valve 102 and a common main relief valve 176 and/or the relief flow capture circuit 104.

Main relief valve 176 may be a hydro-mechanical valve movable to any position between a fully open flow-passing position and a fully closed flow-blocking position. In the exemplary disclosed embodiment, main relief valve 176 may be in the fully open position when a pressure of flowing through shuttle valve 102 reaches about 37 MPa or higher, and in the closed position when the pressure is about 34 MPa or lower.

A straight travel valve 106 may selectively rearrange left and right travel control valves 58, 60 into a parallel relationship with each other. In particular, straight travel valve 106 may include a valve element 107 movable from a neutral position toward a straight travel position. When valve element 107 is in the neutral position, left and right travel control valves 58, 60 may be independently supplied with pressurized fluid from first and second sources 51, 53, respectively, to control the left and right travel motors 65L, 65R separately. When valve element 107 is in the straight travel position, however, left and right travel control valves 58, 60 may be connected in parallel to receive pressurized fluid from only first source 51 for dependent movement. The dependent movement of left and right travel motors 65L, 65R may function to provide substantially equal rotational speeds of opposing left and right tracks (referring to FIG. 1), thereby propelling machine 10 in a straight direction.

When valve element 107 of straight travel valve 106 is moved to the straight travel position; fluid from second source 53 may be substantially simultaneously directed via valve element 107 through both first and second circuits 50, 52 to drive hydraulic cylinders 28, 36, 38. The second stream of pressurized fluid from second source 53 may be directed to hydraulic cylinders 28, 36, 38 of both first and second circuits 50, 52 because all of the first stream of pressurized fluid from first source 51 may be nearly completely consumed by left and right travel motors 65L, 65R during straight travel of machine 10. It should be appreciated that hydraulic control system 150 may alternatively be arranged in a complimentary manner, with respect to straight travel valve 106, such that when valve element 107 is in the straight travel position, left and right travel control valves 58, 60 may be connected in parallel to receive pressurized fluid from only second source 53, while fluid from first source 51 may be substantially simultaneously directed via valve element 107 through both first and second circuits 50, 52 to boom, bucket, stick, and swing control valves 54, 56, 62, 63.

A combiner valve 108 may selectively combine the first and second streams of pressurized fluid from first and second common supply passageways 66, 70 for high speed movement of one or more fluid actuators. In particular, combiner valve 108 may include a valve element 110 movable between a unidirectional open or flow-passing position (lower position shown in FIG. 2), a closed or flow-blocking position (middle position), and a bidirectional open or flow-passing position (upper position). When in the unidirectional open position, fluid from first circuit 50 may be allowed to flow into second circuit 52 (e.g., through a check valve 111) in response to the pressure of first circuit 50 being greater than the pressure within second circuit 52 by a predetermined amount. In this manner, when a stick and/or swing function requires a rate of fluid flow greater than an output capacity of second source 53, and the pressure within second circuit 52 begins to drop below the pressure within first circuit 50, fluid from first source 51 may be diverted to second circuit 52 by way of valve element 110. Although shown downstream of combiner valve 108, it should be appreciated that check valve 111 may alternatively be included upstream of combiner valve 108 or within combiner valve 108, as desired. When in the closed position, substantially all flow through combiner valve 108 may be blocked. When in the bidirectional open position, however, the first stream of pressurized fluid may be allowed to flow to second circuit 52 to combine with the second stream of pressurized fluid directed to control valves 62 and 63, and the second stream of pressurized fluid may be allowed to flow to first circuit 50 to combine with the first stream of pressurized fluid directed to control valves 54-58, depending on a pressure differential across combiner valve 108.

Combiner valve 108 may be modulated continuously to any position between the unidirectional open, closed, and bidirectional open positions. In this manner, a degree of the flow of pressurized fluid may be controlled based on, for example, the commanded velocities of control valve 63, the commanded flow rates of sources 51, 53, and/or the pressure differential across combiner valve 108. For example, valve element 110 may be solenoid movable to any position between the flow-passing positions and the flow-blocking position in response to a current command.

In one embodiment, hydraulic control system 150 may also include warm-up circuitry. That is, the common supply and drain passageways 66, 68 and 70, 72 of first and second circuits 50, 52, respectively, may be selectively communicated via first and second warm-up passageways 109, 113 for warm-up and/or other bypass functions. A warm-up valve 105 may be located in each of warm-up passageways 109, 113 and configured to direct fluid from common supply passageways 66 and 70 to common drain passageways 68 and 72, respectively. Each warm-up valve 105 may include a valve element movable from a closed or flow-blocking position to an open or flow-passing position. In this configuration, when warm-up valve 105 is in the open position, such as during start up of machine 10, fluid pressurized by first and second sources 51, 53 may be allowed to circulate through first and second circuits 50, 52 with very little restriction (i.e., without passing through control valve 63). After warm-up, the valve elements of warm-up valves 105 may be moved to the closed positions so that the pressure of the fluid in first and second circuits 50, 52 may build and be available for control valve 63, as described above. It is contemplated that warm-up passageways 109, 113 and warm-up valves 105 may be omitted, if desired.

Hydraulic control system 150 may also include a controller 112 in communication with operator interface device 48, first and/or second sources 51, 53, combiner valve 108, the supply and drain elements of control valves 54-63, and warm-up valves 105. It is contemplated that controller 112 may also be in communication with other components of hydraulic control system 150 such as, for example, first and second bypass elements 98, 100, straight travel valve 106, and other such components of hydraulic control system 150. Controller 112 may embody a single microprocessor or multiple microprocessors that include a means for controlling an operation of hydraulic control system 150. Numerous commercially available microprocessors can be configured to perform the functions of controller 112. It should be appreciated that controller 112 could readily be embodied in a general machine microprocessor capable of controlling numerous machine functions. Controller 112 may include a memory, a secondary storage device, a processor, and any other components for running an application. Various other circuits may be associated with controller 112 such as power supply circuitry, signal conditioning circuitry, solenoid driver circuitry, and other types of circuitry.

One or more maps relating the interface device position signal, desired actuator velocity, associated flow rates, measured pressures or pressure differentials, and/or valve element position, for hydraulic cylinders 28, 36, 38; left and right travel motors 65L, 65R; and/or swing motor 49 may be stored in the memory of controller 112. Each of these maps may include a collection of data in the form of tables, graphs, and/or equations. In one example, desired velocity and commanded flow rate may form the coordinate axis of a 2-D table for control of the first and second chamber supply elements. The commanded flow rate required to move the fluid actuators at the desired velocity and the corresponding valve element position of the appropriate supply element may be related in another separate 2-D map or together with desired velocity in a single 3-D map. It is also contemplated that desired actuator velocity may be directly related to the valve element position in a single 2-D map. Controller 112 may be configured to allow the operator to directly modify these maps and/or to select specific maps from available relationship maps stored in the memory of controller 112 to affect fluid actuator motion. It is contemplated that the maps may additionally or alternatively be automatically selectable based on modes of machine operation.

Controller 112 may be configured to receive input from operator interface device 48 and to command operation of control valves 54-63 in response to the input and the relationship maps described above. Specifically, controller 112 may receive the interface device position signal indicative of a desired velocity and reference the selected and/or modified relationship maps stored in the memory of controller 112 to determine flow rate values and/or associated positions for each of the supply and drain elements within control valves 54-63. The flow rates or positions may then be commanded of the appropriate supply and drain elements to cause filling of the first or second chambers at a rate that results in the desired work tool velocity.

Controller 112 may be configured to affect operation of combiner valve 108 in response to, for example, the commanded velocities of control valves 54-63, the commanded flow rates of sources 51, 53, and/or the pressure differential across combiner valve 108. That is, if the determined flow rates associated with the desired velocities of particular fluid actuators meet predetermined criteria, controller 112 may cause valve element 110 to move toward the unidirectional flow-passing position to supply additional pressurized fluid to second circuit 52, cause valve element 110 to move toward the bidirectional flow-passing position to supply additional pressurized fluid to first circuit 50 and/or second circuit 52, or inhibit valve element 110 from moving out of the closed position.

Controller 112 may further be configured to control operation of first and/or second sources 51, 53, in conjunction with operation of common main relief valve 176 and/or the relief flow capture circuit 104, to help avoid and/or reduce the magnitude of pressure spikes within hydraulic control system 150. In particular, based on demand generated by interface device 48 and actual system pressures, as generated by one or more pressure sensors 151 (e.g., one or more sensors associated with common supply passage 66 and/or 70 and/or other areas of the system), controller 112 may be configured to selectively increase or decrease the displacement of first and/or second sources 51, 53.

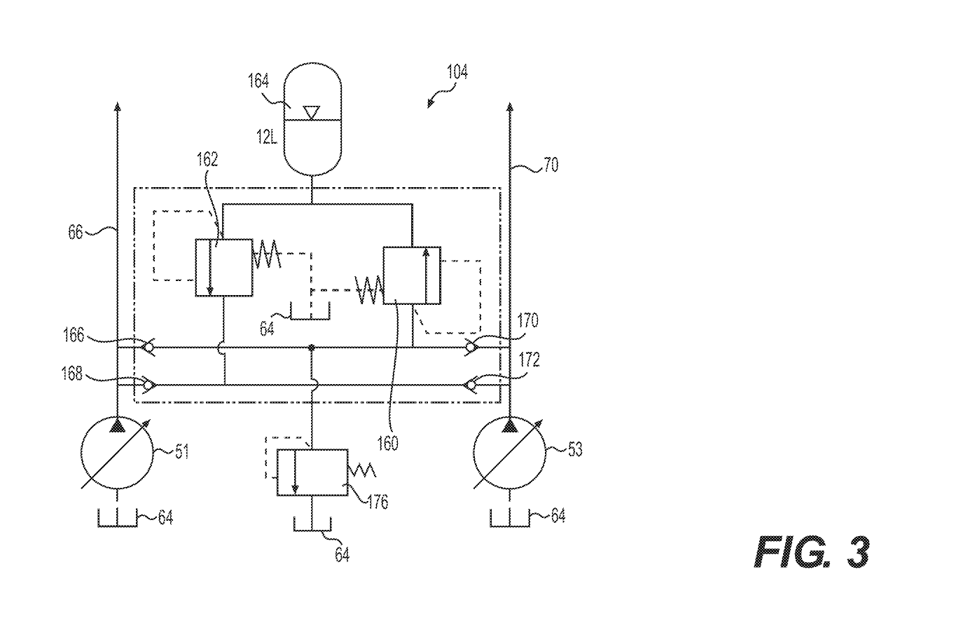

FIG. 3 illustrates a schematic diagram of a relief flow capture circuit 104 in accordance with the disclosure. The relief flow capture circuit 104 is fluidly connected to a first source 51 and a second source 53. The first and second sources 51 and 53 are fluidly connected to the tank 64. The first source 51 is fluidly connected to the first common supply passageway 66. The second source 53 is connected to the second, supply passageway 70. The relief flow capture circuit 104 connects to both the first common supply passageway 66 and the second common supply passageway 70. Check valves 166, 168, 170, and 172 are located proximate to the connections to the first, supply passageway 66 and the second common supply passageway 70. The relief flow capture circuit 104 may include one or more of: a first pressure valve 160, an accumulator 164 and a second pressure valve 162 located in series with respect to each other. The accumulator 164 is a storage reservoir configured to store fluid at or near the pressure of the line to which the accumulator 164 is fluidly connected. As shown in FIG. 3, both the first pressure valve 160 and the second pressure valve 162 may communicate with the tank 64 in order to provide a reference pressure to allow the pressure valves 160 and 162 to detect a pressure with respect to the reference tank pressure.

The first pressure valve 160 (the first pressure valve 160 is the first pressure valve encountered from the perspective of the direction of anticipated fluid flow) is actuated when it detects a pressure above a certain level. For example, in some embodiments the first pressure valve 160 may move from the closed to the open position when a pressure of, for example, at least 340 bar is detected. The second pressure valve 162 is configured to actuate at a different pressure than that of the first pressure valve 160. For example, if the first pressure valve 160 actuates from the close to the open position when at least 340 bar is detected, then the second pressure valve 162 may actuate from the close to the open position when at least 320 bar is detected. For the sake of this document, a pressure which causes a pressure valve to move from the open position to the closed position or from the closed position to the open position may be referred to as a trigger pressure. The trigger pressure for the first pressure valve 160 is higher than the trigger pressure for the second pressure valve 162.

Hydraulic flow through the relief flow capture circuit 104 may bypass the accumulator 164. For example, if the second pressure valve 160 opens and the pressure in the line to which the accumulator 164 is connected drops to less than the pressure in the accumulator 164, then fluid may bypass the accumulator 164. In addition, fluid may flow out of the accumulator 164.

However if the first pressure valve 160 is in an open position but the second pressure valve 162 is in the closed position, then fluid will flow into and be stored in the accumulator 164. Once sufficient fluid accumulates in the accumulator 164 to cause a pressure buildup sufficient to trigger the second pressure valve 162, then the second pressure valve 162 will move from the closed to the open position. If the first pressure valve 160 detects a pressure (or a pressure near the first pressure valve 162 is detected) below the triggering pressure, then it will move from the open to the closed position. However, if the pressure detected by the second pressure valve 162 is still above the trigger pressure for the second pressure valve 162, then the second pressure valve 162 will remain in the open position and fluid will discharge out of the accumulator 164 and then flow through the second pressure valve 162 until the pressure detected by the second pressure valve 162 (or a pressure near the second pressure valve 162 is detected) is below the trigger pressure for the second pressure valve 162.

Fluid discharging of the accumulator 164 will flow through the second pressure valve 162 when the second pressure valve 162 is in the open position and through check valves either 168 or 172 back into either the first common supply passageway 66 or the second common supply passageway 70. In this manner, flow is returned to the rest of the hydraulic circuit. Check valves 168 and 170 to prevent flow from going from either the first common supply passageway 66 or the second common supply passageway 70 into the relief flow capture circuit 104.

Check valves 166 and 170 permit flow from either the first supply passageway 66 or the second supply passageway 70 into the relief flow capture circuit 104 but prevent any flow from coming through the first pressure valve 160 into either the first supply passageway 66 or the second common supply passageway 70.

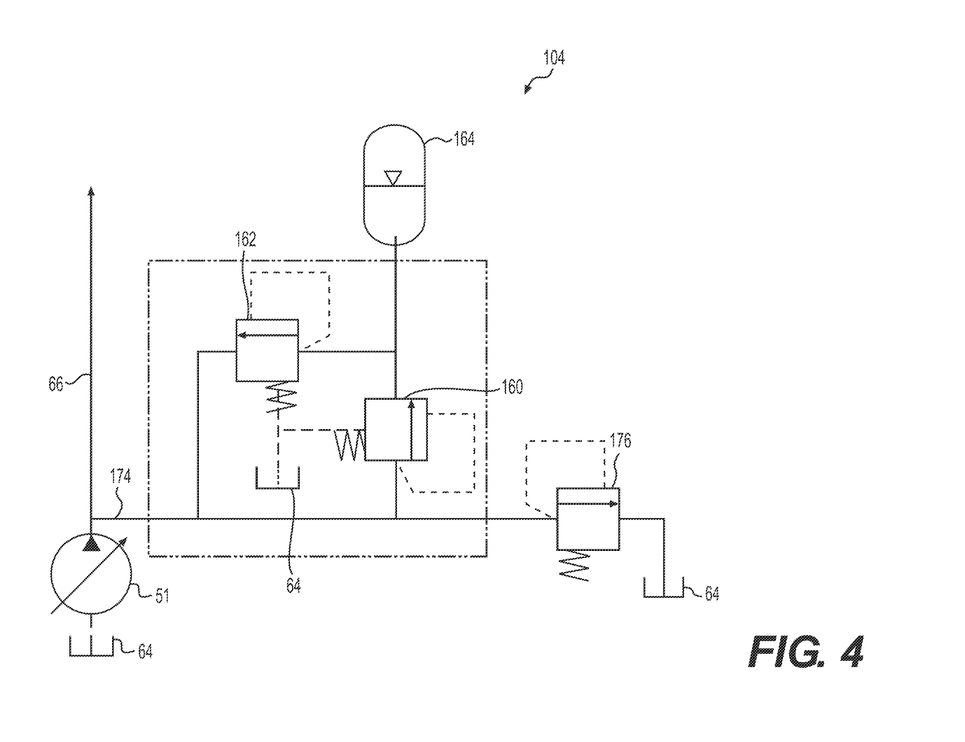

FIG. 4 illustrates another embodiment of a relief flow capture circuit 104 in accordance with the disclosure. The relief flow capture circuit 104 illustrated in FIG. 4 has a single source 51 connected to both a tank 64 and a common supply passageway 66. If a pressure builds up in the common supply passageway 66, flow can be diverted through the relief passageway 174 into the relief flow capture circuit 104. If the pressure is above a certain amount, some flow may bypass the relief flow capture circuit 104 and flow through the main relief valve 176 back into the tank 64.

In some embodiments, it may be desirable to capture the relief flow and send it back into the common supply passageway 66 however, if there is too much pressure, then flow may be sent directly to the tank 64 via the main relief valve 176. In some embodiments, the trigger pressure for the main relief valve 176 is higher that the trigger pressure for the first pressure valve 160.

In instances where the pressure is desired to be relieved but not so high as to cause the main pressure relief valve 176 to open, the flow may go into the relief flow capture circuit 104 if the first pressure valve 160 senses a pressure at or above the trigger pressure, the first pressure valve 160 will move from the closed position to an open position. This will cause flow through the first pressure valve 160 and to either or both the accumulator 164 and the second pressure valve 162. If the second pressure valve 162 is in a closed position, the flow will go into the accumulator 164. If the second pressure valve 162 is in an open position, then flow will go through the second pressure valve 162.

In some embodiments, the triggering pressure causing the first pressure valve 160 to move from a closed open position is about 340 bar. And the trigger pressure causing the second pressure valve 162 to move from the close to the open position is about 320 bar. The trigger pressure causing the main relief valve 176 to move from a closed position to an open position is about 350 bar. In other embodiments, other values for the trigger pressures may be selected by those configuring the hydraulic circuit to best suit the needs or requirements of a particular situation.

As shown in FIG. 4, both the first pressure valve 160 and the second pressure valve 162 may communicate with the tank 64 in order to provide a reference pressure to allow the pressure valves 160 and 162 to detect a pressure with respect to the reference tank pressure.

While the relief flow capture circuit 104 has been illustrated and discussed above with respect to specific hydraulic circuits, one of ordinary skill the art will understand that relief capture circuits in accordance with this disclosure may be used in a variety of different hydraulic circuits and in a variety of different hydraulic circuit settings. The specific examples, such as the example pressures of 320 bar and 349 bar set forth herein should not be regarded as limiting but rather exemplary.

While the first, second, and third valves 160, 162, and 176 are described above as pressure valves, in some embodiments, other types of valves such as solenoid valves may also be used. When solenoid or other types of valves are used in the valves 160, 162, and 176 may be operably connected to the controller 112. The controller 112 may also be operably connected to pressure sensors located at or near the valves that are configured to report sensed pressures to the controller 112. In such embodiments, the controller 112 may operate the valves 160, 162 and 176 to open or close similar to the opening and closing of the self-operating pressure valves 160, 162, and 176 as described above according to the sensed first, second and third pressures. One of ordinary skill the art after viewing this disclosure will understand how to configure a system in accordance this disclosure using solenoid valves, other type of valves, pressure valves or a combination of different types of valves. Furthermore, in other example embodiments, the accumulator 164 may be charged from other functions or sources and discharged into a circuit in accordance with this disclosure. In other embodiments, an accumulator 164 may discharge fluid into other circuit or function such as swing motors, torque assistance motors and/or other hydraulic circuits that may otherwise, without a relief flow capture circuit, experience fluid loss through a relief valve.

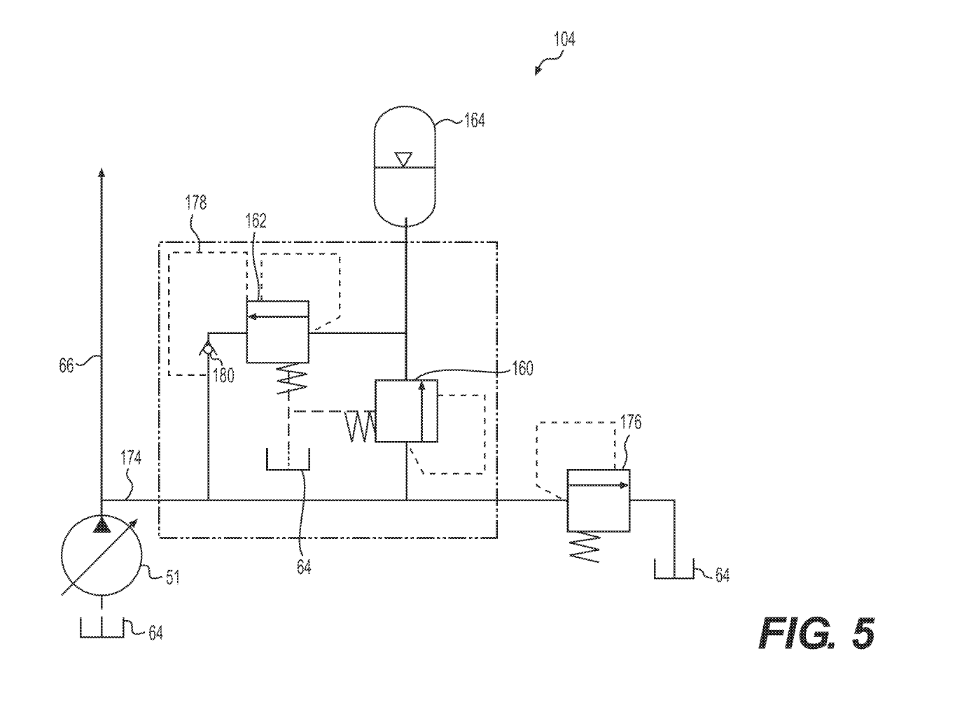

FIG. 5 shows an embodiment similar to that shown in FIG.4 with additional features. For the sake of brevity, the common features of FIGS. 4 and 5 will not be repeated although they are illustrated and identified with like reference numerals. As a result, the discussion of the like parts with respect to FIG. 4 is applicable to FIG. 5 with the following differences.

As shown in FIG. 5, a pump pressure feedback loop 178 is added to the valve 162. A check valve 180 is also added between the valve 162 and the pump 51. These two features assist in providing three main functions. The added check valve 180 prevents the pump 51 from charging the accumulator 164 through the valve 162. The pressure feedback loop 168 permits the accumulator 164 pressure range to be wider. For example, as discussed above with respect to FIG. 4, in some embodiments, a trigger pressure for the valve 160 may be about 340 bar and a trigger pressure for the valve 162 may be about 320 bar. The addition of the feedback loop 178 permits the differential in trigger pressures between valves 160 and 162 to be wider than the example described above. However, if the accumulator 164 pressure range is wide, there may be an energy loss across valve 160 during charging of the accumulator 164. As result, there is a design trade-off between the embodiment shown in FIG. 4 and FIG. 5. One of ordinary skill the art may select how to configure a particular loop after reviewing this disclosure based on the needs and requirements of individual applications.

### INDUSTRIAL APPLICABILITY

Several benefits may be associated with the disclosed hydraulic control system. First, hydraulic control system 150 may be protected from damaging pressure spikes. Second, this methodology may result in machine energy savings without sacrificing machine performance.

Many hydraulic circuits include a relief valve in order to reduce the likelihood of an over pressure situation with in the circuit. Often the relief valve opens the hydraulic circuit to a reservoir, fluid tank, or sump. While this is useful for discharging extra fluid to relief system pressure, it can result in a shortage of hydraulic fluid in the system and/or a waste of pump energy. Use of a relief flow capture circuit as described herein before the main relief valve can assist in several ways.

For example, use of a relief flow capture circuit can relieve pressure from hydraulic system by allowing fluid to flow into the accumulator. The relief flow capture circuit can help mitigate the issue of a shortage of hydraulic fluid in the system by having fluid flow out of the accumulator back into the system. Furthermore, the fluid flows back into the system from the accumulator at a pressure similar to that of the system. As a result, pump energy is not wasted bringing fluid from a tank or reservoir up to system pressure. In addition, allowing fluid to accumulate in the accumulator 164 pressure starts to build within the system, reduces the likelihood of a pump wasting energy by heating hydraulic fluid due to an overpressure situation. As result, hydraulic circuits that utilize the relief capture circuit may result in less energy being wasted.

Some or all of the above mentioned benefits may be achieved by moving a first valve of a relief flow capture circuit from a closed position to an open position when a first pressure is detected to charge an accumulator. The relief flow capture circuit is coupled to a relief flow passageway that is coupled between a supply passageway and a fluid reservoir. The supply passageway is coupled to a pump configured to supply pressurized fluid to a circuit. A second valve of the relief flow capture circuit is moved from a closed position to an open position when a second pressure is detected to discharge the accumulator, wherein the second pressure is lower than the first pressure, and the second valve is in series with the first valve.

It will be apparent to those skilled in the art that various modifications and variations can be made to the disclosed hydraulic control system. Other embodiments will be apparent to those skilled in the art from consideration of the specification and practice of the disclosed hydraulic control system. It is intended that the specification and examples be considered as exemplary only, with a true scope being indicated by the following claims and their equivalents.

We claim:

1. A hydraulic system comprising:
a pump to supply pressurized fluid to a circuit;
a supply passageway coupled between the pump and the circuit;
a relief flow passageway coupled between the supply passageway and a fluid reservoir;
a relief flow capture circuit coupled to the relief flow passageway, the relief flow capture circuit including:
a first valve configured to move from a closed position to an open position when a first pressure is detected;
a second valve in fluid communication with the first valve, the second valve configured to move from a closed position town open position when a second pressure is detected wherein the second pressure is lower than the first pressure; and
an accumulator located between the first and second valves and in fluid communication with both the first and second valves, the accumulator configured to store fluid flowing through the first valve when the first pressure valve is in an open position, the accumulator further configured to outflow fluid through the second valve when the second valve is in an open position.

2. The system of claim 1, further comprising a third valve in fluid communication with the first and second valves and the fluid reservoir.

3. The system of claim 2, wherein the third valve is configured to open to provide fluid communication between the first, second valves and the fluid reservoir when a pressure is detected at a third pressure level.

4. The system of claim 3, wherein the third pressure is higher than the first and second pressures.

5. The system of claim 4, wherein the first pressure is approximately 340 bar, the second pressure is approximately 320 bar, and the third pressure is approximately 350 bar.

6. The system of claim 2, further comprising a fluid source fluidly connected to the first, second, and third valves.

7. The system of claim 2, wherein the first, second and third valves are pressure valves.

8. The system of claim 2, wherein the third valve is located between the reservoir and the other two valves.

9. The system of claim 2, further comprising a controller operatively connected to the first, second and third valves and configured to control the first, second and third valves according to detected pressures reported to the controller.

10. The system of claim 1, further comprising a check valve located between the pump and the second valve, the check valve configured to prevent flow from the pump into an output of the second valve.

11. The system of claim 1, further comprising a check valve located between the pump and the first valve, the check valve configured to prevent fluid from flowing through an input of the first valve toward the pump.

12. A method of capturing relief flow comprising:
moving a first valve of a relief flow capture circuit from a closed position to an open position when a first pressure is detected to charge an accumulator, the relief flow capture circuit coupled to a relief flow passageway that is coupled between a supply passageway and a fluid reservoir, the supply passageway coupled to a pump configured to supply pressurized fluid to a circuit; and
moving a second valve of the relief flow capture circuit from a closed position to an open position when a second pressure is detected to discharge the accumulator, wherein the second pressure is lower than the first pressure, the second valve in series with the first valve,

13. The method of claim 12 wherein the relief flow circuit further includes a relief valve.

14. The method of claim 13, wherein the relief valve, when in an open position, provides open fluid communication between the pump and a reservoir.

15. The method of claim 14, wherein the first pressure is higher than the second pressure and a third pressure which causes the relief flow valve to move from a closed position to an open position is greater than the first pressure.

16. The method of claim 12, maintaining a pressure in the accumulator.

17. The method of claim 12, further comprising accumulating fluid in the fluid accumulator when a pressure sensed near the first valve is greater than the first pressure and a pressure sensed near the second valve is lower than the second pressure.

18. The method of claim 12, further comprising flowing fluid out of the accumulator and through the second valve when the pressure sensed near the second valve is greater than the second pressure.

19. The method of claim 12, further comprising moving the relief valve to an open position when a pressure sensed near the relief valve is greater than a predetermined pressure thereby causing fluid to flow from the source, bypassing the relief flow capture circuit and through the relief valve and into a reservoir.

20. A hydraulic circuit comprising:
means for supplying pressurized fluid to a circuit;
a supply passageway coupled between the means for supplying pressurized fluid and the circuit;
a relief flow passageway coupled between the supply passageway and a fluid reservoir;
a relief flow capture circuit coupled to the relief flow passageway, the relief flow capture circuit including:
a first means for selectively allowing and disallowing fluid flow configured to move from a closed position to an open position at a first pressure;
a second means for selectively allowing and disallowing fluid flow in fluid communication with the first means for selectively allowing and disallowing fluid flow, the second means for selectively allowing and disallowing fluid flow configured to move from a closed position to an open position at a second pressure wherein the second pressure is lower than the first pressure; and
an accumulator located between the first and second means for selectively allowing and disallowing fluid flow and in fluid communication with both the first and second means for selectively allowing and disallowing fluid flow, the accumulator configured to store fluid flowing through the first means for selectively allowing and disallowing fluid flow when the first means for selectively allowing and disallowing fluid flow is in an open position and the second means for selectively allowing and disallowing fluid flow is in a closed position, the accumulator further configured to outflow fluid through the second pressure valve when the second means for selectively allowing and disallowing fluid flow is in an open position.
